(19) United States
(12) Patent Application Publication
(10) Pub. No.: US 2023/0284836 A1
(43) Pub. Date: Sep. 14, 2023

(54) FOOD PROCESSING APPLIANCE AND FASCIA THEREFOR

(71) Applicant: KENWOOD LIMITED, Havant, Hampshire (GB)

(72) Inventors: Adam WESTWOOD, Havant (GB); Andrew PALMER, Havant (GB); Martin HUNT, Havant (GB); Dan TOOLEY, Havant (GB); Jamie WEADEN, Havant (GB); Steve PURVEY, Havant (GB)

(21) Appl. No.: 18/016,505

(22) PCT Filed: Jul. 28, 2021
(86) PCT No.: PCT/GB2021/051948

§ 371 Date: Jan. 17, 2023

(30) Foreign Application Priority Data
Jul. 30, 2020 (GB) 2011869.1
Jul. 30, 2020 (LU) 101958

(51) Int. Cl. A47J 43/07

(52) U.S. Cl. CPC A47J 43/0711

(57) ABSTRACT

A food processing appliance (100) comprises a housing defining an exterior of the appliance. There is disclosed a reversibly attachable fascia (200) arranged to extend over an exterior surface of the appliance (100). The reversibly attachable fascia (200) is typically configured to be reversibly attachable to the appliance (100) without the use of tools.

### FIELD

The present invention relates to a food processing appliance, in particular a stand mixer, to a fascia therefor, and to a kit of parts comprising a plurality of such fascias.

### BACKGROUND

Food processing appliances are typically high-value items that cannot be cheaply and easily replaced. They are also often bulky and it is not possible in the typical household kitchen to store multiple food processing appliances of the same type. This can create a problem as consumers often appreciate being able to vary the appearance of their appliances and/or personalise them, for example to match the décor of their kitchen.

One solution to this is to provide appliances having differing colour/appearance. However, this adds additional logistical and manufacturing costs to their production. This is also not an ideal solution for consumers as they either need to buy new appliances and dispose of their old ones if they wish to change their appliance's appearance, or buy and store multiple appliances of the same type having different appearance.

Another solution, proposed in the Applicant's Patent Publication No. GB2546507A, is to provide an electro-chromic coating on the appliance that allows variable appearances. However, this is complex and expensive.

The present invention aims to at least partially ameliorate the above-described problems of the prior art.

### SUMMARY OF THE INVENTION

According to a first aspect of the invention a fascia for a food processing appliance is provided, the fascia having a body, wherein the fascia is configured to be reversibly attachable to the food processing appliance. As used herein, the term “reversibly attachable” preferably connotes that the fascia can be attached, detached, re-attached again, and so on, repetitively, and that the fascia can be removably attachable.

The fascia is preferably arranged not to require tools to achieve attachment or detachment; this may be achieved by the fascia comprising a mechanical securing mechanism that is preferably operable by hand.

The fascia disclosed herein enables a user to clean more easily the exterior of a food processing appliance, particularly those areas that abut drive-outlets which tend to become soiled with food material spilt from attachments attached thereto. The user is able to remove the fascia and clean it, e.g. using water, without the risk of water leaking into the interior of the food processing appliance. The fascia may be machine-washable; this enables simplified cleaning over present apparatuses—putting a food processor appliance in a dish-washing machine typically leads to damage to the appliance.

Moreover, the fascia enables retailers and other stockists of kitchen products (as well as end users) to quickly modify the appearance of kitchen appliances.

The body of the fascia is preferably shaped to conform to the surface of the body of the food processing appliance. Accordingly, the body may suitably be concave, and/or the body may be saddle-shaped. ‘Saddle-shaped’ meant as referring to a shape bent down on opposing sides, such that there exists a rounded arch between them.

The fascia may be adapted for use with one or more drive outlet of the food processing appliance, preferably such that tool attachments used with at least one of the drive outlets may pass through the fascia. The body of the fascia preferably comprises an aperture. The aperture may be configured to align with a drive outlet of the food processing appliance, and therefore be configured to receive a tool attachment therethrough, when the tool attachment is attached to the drive outlet. This may preferably be a high-speed drive outlet.

The body preferably further includes a retainer by which the fascia is reversibly attachable, the retainer preferably being a mechanical and/or non-magnetic retainer; the retainer may suitably be or perform the function of a lock, latch or clasp. This advantageously provides a secure attachment of the fascia to the food processing appliance.

The retainer may be located on an interior part of a fascia/away from an exterior edge of the fascia. The retainer may be located adjacent (or on an edge of) the aperture, so that it may advantageously be concealed when a lid is on. The retainer preferably comprises a resiliently deformable tab, which may depend from an edge of the aperture.

The retainer preferably further comprises a protrusion extending from the resiliently deformable tab for engaging with a corresponding formation (specifically, an aperture, preferably located proximate a drive outlet) on the food processing appliance. This protrusion may further have ridges to provide strength and rigidity and/or engage with the corresponding formation on the food processing appliance.

The fascia may further comprise a locating element, preferably in the form of a tab, for locating the fascia on the food processing appliance. The locating element preferably includes at least one finger for attaching the fascia to the food processing appliance. The locating element preferably has an arcuate shape for accommodating a drive outlet of the food processing appliance. This drive outlet may be the slow-speed drive outlet, which may be located at a front end of the body. A part of the drive outlet may be used with the arcuate shape of the locating element to locate the fascia on the food processing appliance.

Accordingly, the locating element may be positioned at a first end of the body and the retainer positioned adjacent a second end of the body, where the first end is opposite the second end. The aperture may be located adjacent the second end of the body. The at least one finger may preferably extend towards the second end of the body, by which is preferably meant that the finger extends from the tab of the locating element in the general direction of the second end of the body. The protrusion extending from the resiliently deformable tab preferably extends in a direction towards the first end of the body. Advantageously, this enables the fascia to be removed in a controlled manner; for example the fingers may hold the fascia in position while the retainer is detached.

The fascia preferably further comprises a formation for limiting movement of the fascia. This formation preferably limits movement along the surface of the food processing appliance, but may not substantially limit movement of the fascia towards and away from the food processing appliance.

The fascia may comprise a foodstuff splashguard.

The fascia may preferably further comprise a collar substantially surrounding the aperture. The collar may be the formation for limiting movement of the fascia and/or the foodstuff splashguard.

The resiliently deformable tab may be formed integrally with the collar along at least a portion of the length of the resiliently deformable tab, preferably between 5% and 75% of its length, more preferably between 10% and 60% of its length, yet more preferably between 20% and 50% of its length.

The resiliently deformable tab may be provided separately to the collar, preferably in a concentric arc with the collar.

The collar may preferably comprise at least one support tab at the interface of the collar and the fascia body. This advantageously improves the strength of the interface.

The fascia may preferably be reversibly attachable to a stand mixer.

The fascia is preferably dishwasher safe and/or food safe.

The fascia is preferably arranged to be reversibly attachable to a stand mixer. Stand mixers typically comprise a pedestal and a head that may be pivotable relative to the pedestal, where the head of the mixer typically features multiple drive-outlets. Preferably, the fascia is arranged to remain attached as the head of the stand mixer pivots relative to the pedestal.

According to a further aspect of the invention, there is provided a kit of parts comprising a plurality of fascias preferably as aforesaid, preferably wherein the fascias are different (but each being reversibly attachable to a food processing appliance), more preferably wherein each such fascia has a different decorative finish.

According to a yet further aspect of the invention, there is provided a food processing appliance configured to receive a reversibly attachable fascia, comprising a formation for receiving a retainer of the fascia. Preferably the formation is a recessed aperture, which may be located proximate to a drive outlet. Preferably this is the high-speed drive outlet.

The food processing appliance may further comprise a formation configured to receive a formation for limiting movement of the fascia. This may preferably be a recessed channel. More preferably, this may surround the drive outlet and be configured to receive a collar of the fascia.

The food processing appliance preferably further comprises at least one hole configured to receive at least one finger for attaching the fascia to the food processing appliance.

The holes may be located at a first end of the food processing appliance and the recessed aperture located at a second end of the food processing appliance, wherein the first end is opposite the second end of the body.

The food processing appliance is preferably a stand mixer.

The food processing appliance may incorporate the fascia or kit of parts as aforesaid.

The food processing appliance preferably has a housing defining an exterior surface of the appliance, and the fascia preferably extends over at least a portion of the exterior surface. The fascia is preferably shaped to conform to said portion of the exterior surface of the appliance.

The fascia preferably includes an aperture for receiving a cover; the cover may for example cover a portion of the appliance that may be used at will (by covering or uncovering said portion), such as an operating function like a drive outlet. By contrast, the fascia otherwise preferably only covers a portion of the exterior surface that has no operating function, and in that sense the fascia preferably performs a decorative function.

The fascia may comprise an aperture corresponding to a drive outlet of the food processing appliance, preferably a high-speed drive outlet; more preferably the aperture is configured to receive an attachment tool attachable to the drive outlet of the food processing appliance.

The food processing appliance may further comprise a formation to fit a formation for limiting movement of the fascia, which is provided on the fascia. The formation on the food processing appliance may be a recessed channel, which preferably surrounds a drive outlet such as the high-speed drive outlet. The formation for limiting movement of the fascia may be a collar, which preferably fits within the recessed channel. Advantageously this prevents the movement of the fascia along the surface of the food processing appliance, but does not hinder movement towards and away from the appliance, for example when the fascia is attached or detached.

The fascia preferably comprises a retainer and the food processing appliance exterior comprises a formation for receiving the retainer. Preferably, the retainer comprises a resilient tab and a protrusion therefrom, which fits within a recessed aperture on the food processing appliance exterior.

The fascia preferably comprises a locating element, which may comprise a tab and at least one finger for attaching the fascia to the food processing appliance, and the food processing appliance comprises at least one hole configured to receive the at least one finger. The at least one finger may be reversibly inserted in the at least one hole. The locating element may be proximate a drive outlet and the tab preferably has an arcuate shape for accommodating a drive outlet of the food processing appliance, wherein the drive element is preferably a slow-speed drive outlet.

The housing of the food processing appliance may define an aperture and the fascia may define a corresponding aperture, and these apertures may be adjacent to a drive outlet. The housing of the food processing appliance preferably defines a run-off aperture configured to permit liquid to flow off a surface of the housing and the fascia may define an opening located corresponding to the run-off aperture. Advantageously, this provides a run-off for leakage of foodstuffs, but also provides an aperture through which the lid or cover of a drive outlet may be removed.

Preferably, the fascia fixingly locates on the food processing appliance at at least three points.

The food processing apparatus may be a stand mixer. Preferably, the fascia extends over, and is attached to, a component, preferably a head, of the stand mixer that may be pivotable relative to a second component thereof, preferably a pedestal.

According to a further aspect of the invention, there is provided a method comprising the steps of: providing a food processing appliance having attached thereto a first removable fascia; removing the first removable fascia; and attaching a second removable fascia, the fascia or fascias preferably being as aforesaid.

According to a further aspect of the invention, there is provided a food processor (or a food processing appliance) having a removable fascia, preferably as aforesaid.

According to a further aspect of the invention a food processing appliance is provided which comprises a housing substantially enclosing a motor, the appliance further comprising a removably-attachable fascia extending over an exterior surface of the appliance, wherein the removably-attachable fascia is configured to be lockable to the appliance and be unlockable from the appliance without the use of tools.

Preferably the fascia further defines a through-hole therethrough located corresponding to a drive-outlet of the appliance.

Preferably the fascia comprises a collar substantially surrounding the through-hole, the collar preferably being configured to cover a join within the drive-outlet when the fascia is attached to the appliance.

Preferably, the fascia locks to the appliance via a mechanical locking means.

Preferably the mechanical locking means is a resiliently deformable tab.

Preferably, the fascia fixingly locates on the appliance at at least three points.

Preferably, the appliance comprises a recessed aperture shaped and configured to receive the mechanical locking means when the fascia is attached to the appliance.

Preferably, the housing of the appliance defines a run-off aperture configured to permit liquid to flow off a surface of the housing, and the fascia defines an aperture located corresponding to the run-off aperture.

Preferably, the fascia is dish-washer safe.

Preferably, the fascia is food-safe.

Preferably, the fascia comprises a user interface configured to, when the fascia is attached to the appliance, be in electronic communication, and preferably in bi-directional electronic communication, with the appliance.

Preferably, the appliance is a stand-mixer.

Preferably, the fascia extends over, and is preferably attached to, a component, preferably a head, of the stand mixer that is pivotable relative to a second component thereof, preferably a pedestal.

According to a further aspect of the invention, a kit of parts is provided which may comprise a kitchen appliance comprising a housing substantially surrounding a motor thereof; and, two or more fascias interchangeably removably attachable to an external surface of the housing for changing an external appearance thereof.

Preferably, the fascias are removably attachable without tools to the appliance.

Preferably, the fascias are configured to attach mechanically to the appliance.

Preferably, the fascias comprise a resiliently-deformable locking mechanism.

Preferably, the kitchen appliance is a stand-mixer.

According to a further aspect of the invention, a method is provided which may comprise steps of: providing a kitchen appliance having attached thereto a first removable fascia extending over the surface of a housing thereof; removing the first removable fascia without the use of tools; attaching, without use of tools, a second fascia having differing appearance to the first removable fascia.

Preferably, the step of removing the first removable fascia without the use of tools comprises resiliently deforming a resilient locking means by hand to unlock the resilient locking means from an aperture of the appliance.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

Whilst the invention has been described in the field of domestic food processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances, and any reference to “food” herein may be replaced by such working mediums.

The invention described here may be used in any kitchen appliance and/or as a stand-alone device. This includes any domestic food-processing and/or preparation machine, including both top-driven machines (e.g. stand-mixers) and bottom-driven machines (e.g. blenders). It may be implemented in heated and/or cooled machines. It may be used in a machine that is built-in to a work-top or work surface, or in a stand-alone device. The invention can also be provided as a stand-alone device.

“Food processing” as described herein should be taken to encompass chopping, whisking, stirring, kneading, mincing, grinding, shaping, shredding, grating, cooking, freezing, making ice-cream, juicing (centrifugally or with a scroll), or other food-processing activities involving the physical and/or chemical transformation of food and/or beverage material by mechanical, chemical, and/or thermal means.

### BRIEF DESCRIPTION OF DRAWINGS

One or more aspects will now be described, by way of example only and with reference to the accompanying drawings having like-reference numerals, in which:

FIG. 1a shows a perspective view of an assembled food processing appliance and cover according to the present invention;

FIG. 1b shows a perspective view of the food processing appliance and cover of FIG. 1a in a disassembled state;

FIG. 2a shows a perspective view of the top of the food processing appliance of FIG. 1a;

FIG. 2b shows a perspective, side-on view of the food processing appliance of FIG. 1a;

FIG. 3a shows a perspective drawing of the cover of FIG. 1a oriented upside-down; and,

FIG. 3b shows a perspective drawing of the cover of FIG. 1a oriented right-way-up.

### SPECIFIC DESCRIPTION

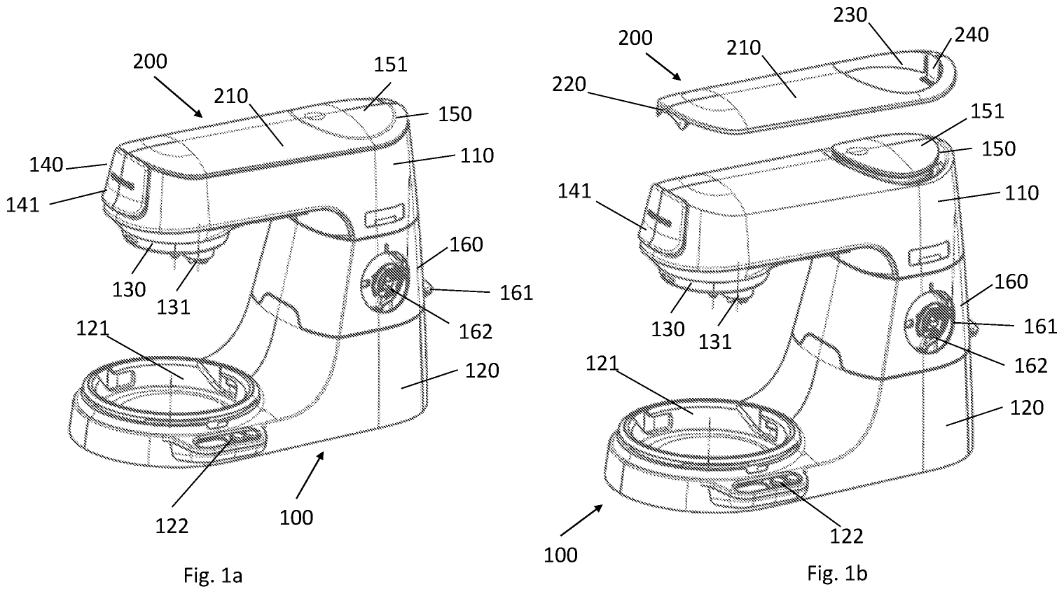

FIGS. 1a and 1b show a food processing appliance 100 (in this case a stand mixer) with a cover 200 that is releasably-attachable without tools to the food processing appliance 100. Multiple covers 200 may be provided having differing colours, and/or with differing patterns formed on them. The user may thus easily change the appearance of their food processing appliance 100 by simply removing the cover 200 and replacing it with another cover 200. As such the covers 200 serve as fascias covering an exterior of the appliance 100 and changing its appearance.

Food processing appliance 100 has a head 110 supported by a pedestal 120 via an upright stand-portion 160. The exterior of the food processing appliance 100 is formed by a housing which may be a permanent, fixed shell that is provided to house the internal components of the stand mixer 100, such as, for example, the motor, the electronics, power supply arrangements, gearing, and other internal components. The head 110 is provided with a downwardly-facing drive-outlet 130. This may be a planetary drive outlet 130 for use in kneading, stirring, and/or whisking using suitable tools attached to the attachment port 131 of the outlet 130.

A frontal drive-outlet 140 is provided facing forwards (i.e., in the direction of extension of the head 110 away from the stand 160). The frontal drive-outlet 140 is typically a low-speed drive outlet. The frontal drive outlet 140 is provided with a removable frontal drive outlet cover 141 that is attached e.g., magnetically, or in another fashion permitting removable attachment.

An upper drive outlet 150 is provided facing upwards, away from the pedestal 120, on an upper surface of the head 110. The upper drive outlet 150 is preferably a concentric dual-drive outlet such as that described in the Applicant's Patent Publication No. GB2520937A, the entire content of which is hereby incorporated by reference, as these provide multiple drives and drive-speeds. The upper drive outlet 150 is typically a high-speed drive outlet. The upper drive outlet 150 is preferably located above the stand-portion 160 so as to be directly supported by it. A removable upper drive outlet cover 151, preferably magnetically attached or using other reversible attachment means, is provided to cover the upper drive outlet 150 when not in use. The upper drive outlet 150 may be recessed within the housing of the food processing appliance 100, such that a side-wall of the housing/permanent shell of the appliance surrounds the upper drive outlet 150.

The fascia 200 and the covers 141, 151 are conformed to the shape of the exterior housing of the food processing appliance 100 to which they are attached. In this case, the fascia 200 is concave and saddle-shaped to correspond to the shape of the body of the head 110. As used herein, the term “saddle-shaped” preferably connotes a shape bent down on opposing sides, such that there exists a rounded arch between them. The fascia 200 is also preferably raised at the end in the vicinity of the upper drive outlet 150, to conform to the shape of the head 110 in this region. The fascia 200 is preferably curved downwards at the end in the vicinity of the frontal drive outlet 140, to conform to the shape of the head 110 in this region.

Pedestal 120 has a bowl-seat 121 in which a bowl (not shown) may be located such that the tools attached to the downwardly-facing drive outlet 130 depend into it to process food therein. A control panel and digital display 122 connected to e.g., weighing scales provided for weighing the contents of the bowl may also be provided on the pedestal 120.

The upright stand portion 160 is provided with a control knob 162 for controlling a motor of the appliance, and potentially a heating and/or cooling element for heating and/or cooling the contents of the bowl. A locking-lever 161 is provided on the rear of the appliance 100 (i.e., that side facing away from the direction of extension of the head 110) for easy access. Actuation of the locking-lever 161 permits the head 110 to pivot relative to the pedestal 120 towards an upwardly-tilted position to permit better access to the bowl. The stand 160 may pivot with the head 110 or remain statically fixed to the pedestal 120.

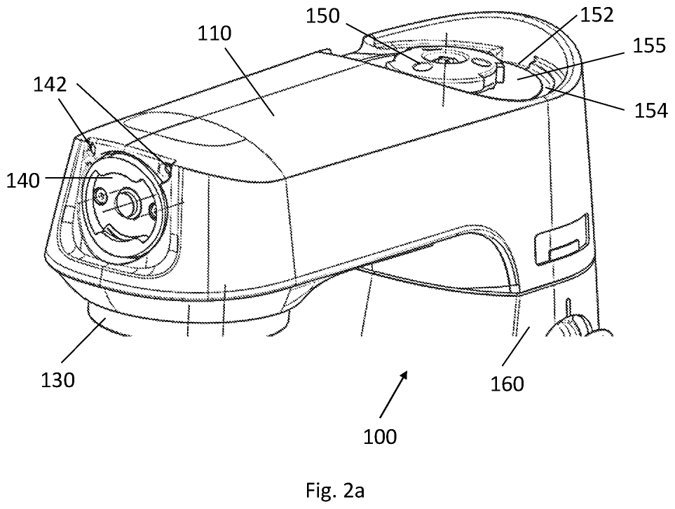

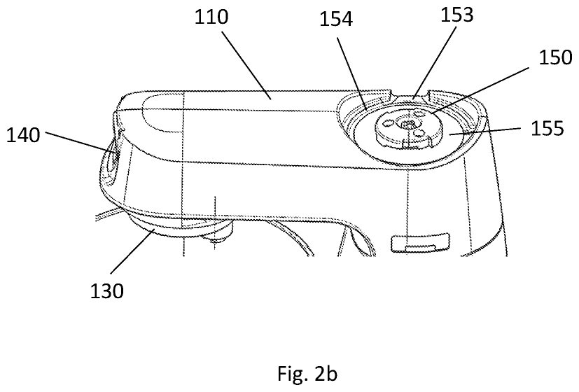

FIGS. 2a and 2b show details of the head 110, forward drive outlet 140, and upper drive outlet 150, with the fascia 200 and the covers 141, 151 removed.

The forward drive outlet 140 has fixing means provided therein for the attachment of an attachment tool of the food processing appliance (e.g., a light attachment such as a blending or juicing attachment) therein, and a drive shaft to which an attachment can attach to receive rotary drive. The forward drive outlet 140 includes fixing holes 142 defined through the permanent shell of the appliance 100 in which the fascia 200 can be removably inserted.

The upper drive outlet 150 is similarly provided with an attachment formation to which attachments (e.g., heavier attachments than the light attachments, requiring the support of the stand 160, such as those including blending or food-processor goblets) may be attached. A recessed aperture 152 is provided in the upper drive outlet 150 for releasably receiving a mechanical locking, latching, or clasping element or the like, in the form of a retainer 240, of the fascia 200. As the aperture 152 is recessed it is not visible during ordinary use, which is advantageous as it is considered unsightly. The recessed aperture 152 may also be provided in the housing surrounding the upper drive outlet 150.

The upper drive outlet 150 may include a fixed or stationary metal plate 155 around the attachment formation. In an embodiment, when pressed into the recessed aperture 152, the retainer of the fascia 200 may deflect around the edge of the metal plate 155 and snap fit under the metal plate 155.

A notch 153 is provided in a side-wall of the shell of the appliance 100 surrounding the upper drive outlet 150, for facilitating removal of the upper drive outlet cover 151 by allowing the user to get their fingers under it. The notch 153 also permits drainage of fluid spilled into the upper drive outlet 150 away from the appliance 100. This notch 153 is an example of a run-off aperture provided in the housing. The fascia 200 may include an opening (not shown), for example in the form of a hole or notch in the collar 230 of the fascia 200, corresponding to the notch 153 to facilitate use of the notch 153 as a run-off aperture. This opening further enables the upper drive outlet cover 151 to be removed while the fascia 200 remains in place on the head. This is achieved by a user placing their finger in this opening to remove the upper drive outlet cover 151. To enable simple removal of the upper drive outlet cover 151 without moving the fascia 200, the notch in the upper drive outlet cover 151 and the notch in the fascia 200 may be differently shaped and/or differently sized. Alternatively, the upper drive outlet cover 151 may comprise a formation which enables the user to remove it; for example the upper drive outlet cover 151 may comprise a handle and/or a recess that enables the user to grip the upper drive outlet cover 151 and pull it away from the appliance 100.

Where collar 230 of the fascia 200 comprises an opening to enable removal of the upper drive outlet cover 151, the fascia 200 may be relatively weak in this area. To reduce weakness, the opening is typically arranged to comprise only a small portion of the circumference of the collar 230 of the fascia 200, e.g. less than 5% or less than 10% of the circumference.

More generally, a variety of means may be provided to enable removal of the upper drive outlet cover 151 without needing to remove the fascia 200. For example, the collar 230 of the fascia 200 may comprise a flexible portion (or a button) that can be depressed, where the depression of this flexible portion results in the flexible portion interacting with the notch 153 of the appliance 100 to force the upper drive outlet cover 151 away from the appliance. Such an arrangement can enable removal of the upper drive outlet cover 151 without substantially affecting the structural integrity of the fascia 200.

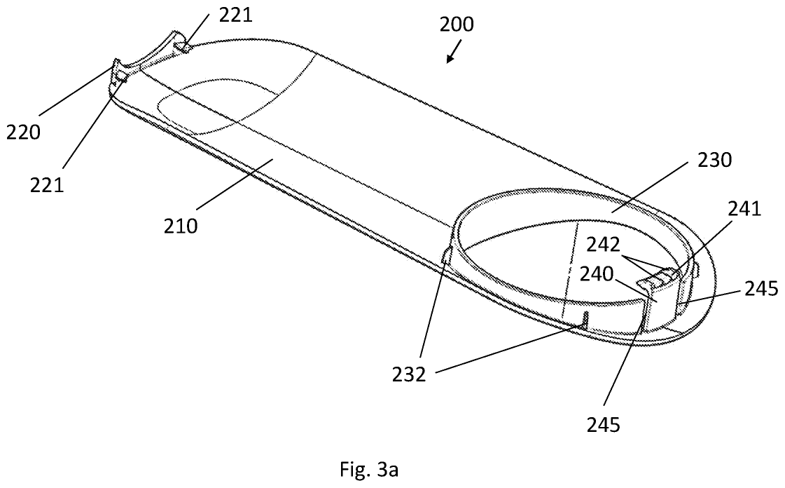

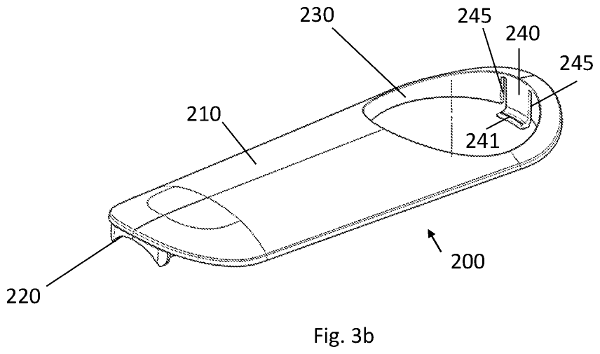

FIGS. 3a and 3b illustrate the fascia 200. The fascia 200 comprises a body in the form of an elongate board 210, which is shaped to conform to the surface of the housing of the food processing appliance to which it is to be attached. In this case, it is shaped as a concave saddle-shape. The fascia 200 may also have a forward locating element extending downwardly (i.e., substantially at a right-angle to the board 210, such that it will extend downwardly when the cover is placed atop the appliance 100). When the fascia 200 is attached to the appliance 100, the locating element abuts the forward drive outlet 140. The locating element is formed as a tab 220, which has mechanical fixing elements 221, for example pins or fingers, extending from it such that, when the fascia 200 is attached, they extend into the fixing holes 142 to help mechanically locate and retain the fascia 200 on the appliance 100. In the illustrated embodiment the fingers 221 extend towards the opposite end of the cover substantially at a right angle to the forward tab, i.e. towards the upright stand portion of the appliance. The retaining tab 220 may further feature a substantially arcuately shaped end, so as to conform around the frontal drive outlet 140 and prevent blocking the attachment of tool attachments to the outlet.

When attached, the fascia 200 is thus located on the appliance 100 at at least three locations (at the aperture 152 via the tab 240, and at the fixing holes 142 via the fingers 221). This ensures secure mechanical attachment.

In an alternative, a single fixing element may be provided on the forward tab corresponding to a single fixing hole in the appliance. Such a fixing element may be a pin or a protrusion of any suitable shape to fit into a corresponding recess of the appliance, for example, in the forward drive outlet 140 or housing on the forward portion of the head 110 of the stand mixer. Equally, a plurality of fixing elements of any suitable number may be provided on the forward retaining tab 220 with a corresponding number of fixing holes in the appliance 100.

The board 210 has an aperture defined vertically through it to permit access to the upper drive outlet 150 through the board 210 when the fascia 200 is attached to the appliance 100. In this way, for example, blender or food processing attachments may be attached to the drive outlet 150 to receive drive whilst the fascia 200 is attached, and the drive outlet 150 may be releasably covered by the cover 151. The aperture is surrounded by a downwardly-depending collar 230 that, when the fascia 200 is attached to the appliance 100, can preferably be dimensioned and arranged to cover the join between the outlet 150 and the shell of the appliance 100. The collar 230 fits within a recessed annular channel 154 on the body of the food processing appliance around the drive outlet 150. This positions the collar 230 and prevents movement of the fascia relative to the appliance 100 in a direction along the surface of the food processing appliance. The collar 230 may comprise support tabs 232 at the join between the collar 230 and the body of the fascia 200. These provide strength and structural integrity to the collar 230 and the interface. Additionally, the fit of the collar 230 with the appliance is preferably sufficiently snug to prevent fluid or other foodstuffs from leaking under the fascia 200, so that the collar acts as a foodstuff splashguard.

Alternative arrangements may also be implemented to limit the movement of the cover with respect to the appliance. For example, the perimeter of the fascia 200 may comprise a collar, which fits within a corresponding channel on the surface of the appliance. Alternatively, the fascia 200 may comprise one or more individual protruding elements which engage with corresponding recesses on the appliance body, or vice versa.

To releasably and mechanically retain the fascia 200 on the appliance 100, the retainer 240 typically comprises a resilient tab that extends downwardly from the board 210, located so as to correspond to the recessed aperture 152 and be located inside it when the fascia 200 is attached to the appliance 100. A hook or protrusion 241 is provided extending horizontally from the tab 240 for holding the fascia 200 mechanically on the appliance 100 by locking into a corresponding notch/recess within the aperture 152. Typically, the protrusion 241 comprises a series of pins, furthermore the protrusion 241 may comprise ridges 242, which increase its strength, rigidity and structural integrity without adding unnecessary bulk or weight. The increased rigidity of the protrusion 241 compared to the resilient tab 240 is important for ensuring that the attachment remains secure, and the ridges ensure this can be achieved when both elements are formed of the same material. The resilient tab 240 and protrusion 241 are typically formed as one formation to reduce manufacturing complexity.

The resilient tab of the retainer 240 depends downwardly from the fascia 200 at the edge of the aperture in the board 210. The retainer 240 is located on an edge of the aperture towards the backward (e.g. towards the stand 160) end of the board 210.

The tab 240 may be integrally formed with the collar 230 along at least part of its length (for example, 20-50% of its length, the length referring to the direction in which the tab depends downwardly from the board 210) to lend additional strength and simplify production. It will be appreciated that the length of the tab formed integrally with the collar can be varied between 0% and 100% to achieve a desired strength and resilience. The tab 240 is demarcated either side by slits 245 in the collar 230, which enables resilient movement of the tab 240 separate to the collar 230. Alternatively, the tab 240 may be formed separately to, but shaped as a concentric arc with, the collar 230 so as to reduce its visual impact and to allow better resilient deformation by extending the length of the tab 240 that may be deformed.

Alternatively, the tab 240 depending from the board may be rigid, while the corresponding formation which receives the tab 240 in the housing or upper drive outlet of the appliance 100 may be resiliently deformable. This permits the tab 240 to move between the locked and unlocked position by deforming a receiving aperture or notch in the appliance 100.

More generally, a variety of mechanical retaining mechanisms may be provided that provide a snap fit between the fascia 200 and the appliance 100. The described embodiment of a resiliently deformable tab 240 depending from the fascia 200 and being received in an aperture 152 or notch of the upper drive outlet 150 or housing may be an example of such a snap fit mechanism; specifically, it is a cantilever snap fit mechanism. Other alternatives will be apparent to those skilled in the art, such as snap fits with an annular configuration, for example, a ball and socket joint or snap fastener. Other alternative snap fit mechanisms may also be used. It will be appreciated that the male and female parts of the snap fit mechanism may be provided on either the fascia 200 or on the appliance 100 in different embodiments.

To release the tab 240 from the recessed aperture 152, the user can simply bend the resilient tab 240 until the hook protrusion 241 is freed from its aperture/notch, and then pull the fascia 200 upwards and move it forward to remove the fingers 221 from the fixing holes 142. The fascia 200 can thus be attached and released form the appliance 100 without the use of tools that might be lost and which would add additional expense and complexity.

In the illustrated embodiment, the resilient tab 240 is bent so as to deform away from the forward end of the stand mixer 100, i.e. towards the stand 160, in order to free the protrusion 241 from the aperture/notch 152 in the housing. Such a user deformation of the locking mechanism will tend to urge the fascia 200 as a whole, including the forward retaining tab 220, towards the stand 160. Such urging will tend to retain the fingers 221 into their corresponding fixing holes 142 in the forward drive outlet, so the fascia 200 will not fly off as the tab is deformed. The interaction of the collar 230 with the recessed channel 154 prevents movement of the fascia 200 in a lateral direction. The locating element 220 will be retained in place as the tab 240 is deformed and the opposite end of the fascia 200 is lifted as the cover is removed from the locked position. The fascia 200 is removed from the device when the fascia 200 is slid forward, releasing the fingers 221 from the fixing holes 142. As such the act of releasing the snap mechanism does not permit an uncontrolled removal of the fascia 200.

In the described embodiment, no substantial deformation of the body of the fascia 200 is required for removal or attachment of the fascia 200. Thus, the fascia 200 can be easily attached and detached with the strength of a user's hand or one of more fingers, without the need to substantially anchor the appliance 100 in the action of removing the cover. It will be appreciated that where a great deal of strength is required to remove a panel or cover from an item of kitchen equipment, a commensurate amount of force must be supplied to anchor the body of the equipment to be sure of a safe removal of the cover and prevent the appliance from being knocked over or damaged, or to prevent injury to the user. One advantage of the present invention may be to provide a secure mechanical attachment of the fascia 200 to the appliance 100, which can nevertheless be overcome by a user with a force less than that which could knock over or damage the appliance 100 as a whole.

The fascia 200 may be formed of any food-safe, dishwasher-safe material. For example, it may be formed of a metal such as stainless-steel. Alternatively, a food-safe, dishwasher-safe plastic may be used, such as, for example, Nylon. In a further alternative, a dishwasher-safe, food-safe ceramic or glass may be used.

The housing of the appliance 100 and the fascia 200 may be made of different substances in order to combine the advantages of different materials. For example, the housing of the appliance 100 may be made of a metal such as an ordinary steel (e.g., mild steel), which is cheap, durable, and easy to shape. In contrast the fascia 200 may for example be made of a decorative material, for example polished stainless steel or a reflective plastic.

The fascia 200 may comprise electronic components, such as, for example, a user interface such as a touch-screen user interface, that communicates, and preferably bi-directionally communicates with internal components of the appliance 100 such as, for example, a motor and/or a heating element. This communication may be either via a wired interface or wirelessly (e.g., via WiFi or Bluetooth, or a similar wireless communication protocol, and preferably a near-field wireless communication protocol having a range of 20 m or less, and more preferably 1 m or less). The user interface on the fascia 200 may thus be swapped for a different user interface by exchanging the fascia 200 for a different one. The user interface on the fascia 200 may receive feedback from temperature and/or weight sensors associated with the appliance 100, and transmit instructions for controlling the motor and/or heating/cooling element of the appliance 100 input by the user into the user interface.

“Food safe” in this context means any substance that does not shed substances harmful to human health in significant quantities. For example, it should be BPA-free.

“Dishwasher safe” means that it should be physically and chemically stable during prolonged exposure to the conditions prevailing within a dishwasher machine. For example it should be able to withstand exposure to a mixture of water and a typical dishwasher (e.g., cleaning agent at temperatures of 82 degrees centigrade for as long as 8 hours without visibly degrading (e.g., cracking).

“Mechanically” as defined herein means with the use of solid physical components and not, e.g., through the use of magnets.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1-25. (canceled)

26. A fascia for a food processing appliance comprising a body, wherein the body is configured to be reversibly attachable to the food processing appliance.

27. The fascia according to claim 26, wherein the body is shaped to conform to a surface of the body of the food processing appliance, optionally wherein the body is concave, and preferably wherein the body is saddle-shaped.

28. The fascia according to claim 26, wherein the body includes an aperture, preferably wherein the aperture is configured to align with a drive outlet of the food processing appliance and is configured to receive a tool attachment therethrough.

29. The fascia according to claim 26, wherein the body includes a retainer by which the fascia is reversibly attachable, the retainer preferably being a mechanical and/or non-magnetic retainer, optionally wherein the body comprises an aperture configured to align with a drive outlet of the food processing appliance, wherein the retainer is located adjacent the aperture.

30. The fascia according to claim 29, wherein the retainer comprises a resiliently deformable tab, preferably wherein the retainer further comprises a protrusion extending from the resiliently deformable tab for engaging with a corresponding formation on the food processing appliance.

31. The fascia according to claim 26, further comprising a locating element, preferably in the form of a tab, for locating the fascia on the food processing appliance, optionally wherein the locating element includes at least one finger for attaching the fascia to the food processing appliance.

32. The fascia according to claim 31, wherein the locating element has an arcuate shape for accommodating a drive outlet of the food processing appliance.

33. The fascia according to claim 31, wherein the body includes a retainer by which the fascia is reversibly attachable, and wherein the locating element is located at a first end of the body and the retainer is located adjacent a second end of the body.

34. The fascia according to claim 26, further comprising a formation for limiting movement of the fascia.

35. The fascia according to claim 28, further comprising a collar substantially surrounding the aperture.

36. The fascia according to claim 30, further comprising a collar substantially surrounding the aperture, and wherein the resiliently deformable tab is formed integrally with the collar along at least a portion of the length of the resiliently deformable tab, preferably between 5% and 75% of its length, more preferably between 10% and 60% of its length, yet more preferably between 20% and 50% of its length.

37. A kit of parts comprising a plurality of fascias each according to claim 26, wherein each such fascia has a different decorative finish.

38. A food processing appliance configured to receive a reversibly attachable fascia, comprising a formation for receiving a retainer of the fascia, preferably wherein the receiving formation is a recessed aperture, and/or wherein the receiving formation is configured to receive a formation for limiting movement of the fascia, preferably wherein the receiving formation is a recessed, preferably annular, channel.

39. The food processing appliance according to claim 38, further comprising at least one hole configured to receive at least one finger for attaching the fascia to the food processing appliance.

40. The food processing appliance according to claim 38, incorporating a fascia having a body configured to be reversibly attachable to the food processing appliance or a kit of parts wherein each such fascia has a different decorative finish, and wherein the food processing appliance has a housing defining an exterior surface of the appliance, and the fascia extends over at least a portion of the exterior surface.

41. The food processing appliance according to claim 40, wherein the fascia comprises an aperture corresponding to a drive outlet of the food processing appliance, preferably a high-speed drive outlet, more preferably wherein the aperture is configured to receive an attachment tool attachable to the drive outlet of the food processing appliance, and optionally wherein the appliance has both a first, preferably high-speed, drive outlet and a second, preferably low-speed, drive outlet, and the fascia is shaped so as to accommodate both such outlets.

42. The food processing appliance according to claim 40, wherein the fascia fixingly locates on the stand mixer at at least three points, and/or wherein the housing defines a run-off aperture configured to permit liquid to flow off a surface of the housing and/or wherein the fascia defines an opening located corresponding to the run-off aperture.

43. The food processing appliance according to claim 40, wherein the fascia comprises a user interface configured to, when the fascia is attached to the appliance, be in electronic communication, and preferably in bi-directional electronic communication, with the appliance.

44. The food processing appliance according to claim 40, wherein the fascia extends over, and is preferably attached to, a component, preferably a head, of the stand mixer that is pivotable relative to a second component thereof, preferably a pedestal.

45. A food processor having a removable fascia, preferably a removable fascia according to claim 26.
